(19) United States
(12) Patent Application Publication
(10) Pub. No.: US 2014/0357770 A1
(43) Pub. Date: Dec. 4, 2014

(54) Silicone Resins

(71) Applicant: Dow Corning Corporation, Midland, MI (US)

(72) Inventors: Michael Depierro, Midland, MI (US); David Pierre, BXL (Watermael-boit) (BE); Vincent Rerat, Tubize (BE)

(73) Assignee: Dow Corning Corporation, Midland, MI (US)

(21) Appl. No.: 14/358,316

(22) PCT Filed: Nov. 14, 2012
(86) PCT No.: PCT/US12/65024

§ 371 Date: May 15, 2014

(30) Foreign Application Priority Data
Nov. 17, 2011 (GB) 1119826.4

(51) Int. Cl. C08G 77/04; C08L 83/04; C08L 21/00

(52) U.S. Cl. CPC C08G 77/04; C08L 21/00; C08L 83/04
USPC 524/166; 528/25; 525/105; 524/405; 524/506; 524/445; 524/414; 524/444; 524/451; 524/388; 524/436; 524/437; 524/415; 524/404; 524/424; 524/157; 524/418; 524/216; 524/387; 525/57

(57) ABSTRACT

The invention relates to silicone resins comprising metallosiloxane which contains Si—O-Metal bonds and borosiloxane containing Si—O—B bonds and potentially Si—O—Si and/or M-O-M and/or B—O—B bonds. It also relates to the preparation of such silicone resins and to their use in thermoplastic or thermosetting organic polymer or rubber or thermoplastic/rubber blends compositions to reduce the flammability or enhance scratch and/or abrasion resistance of the organic polymer compositions. It further relates to coatings made of such silicone resins for scratch resistance enhancement or flame retardant properties.

The invention relates to silicone resins comprising metallosiloxane which contains Si—O-Metal bonds and borosiloxane containing Si—O—B bonds and potentially Si—O—Si and/or M-O-M and/or B—O—B bonds. It also relates to the preparation of such silicone resins and to their use in thermoplastic or thermosetting organic polymer or rubber or thermoplastic/rubber blends compositions to reduce the flammability or enhance scratch and/or abrasion resistance of the organic polymer compositions. It further relates to coatings made of such silicone resins for scratch resistance enhancement or flame retardant properties.

Development of efficient halogen-free flame retardant additives for thermoplastics and thermosets is still a great need for many industrial applications. New upcoming regulation such as European harmonized EN45545 norm as well as growing green pressure are pushing the market to develop new effective halogen-free solutions. In the recent years, many researches were made in the field of halogen-free flame retardant. Silicone-based materials are of particular interest in this field.

Even if the synthesis of borosiloxane structures are known in the literature, the obtention of borometallosiloxanes presenting unexpected higher fire retardant efficiency and outstanding thermal stability compared to their “pure” silicone based and non boronated counterparts were not reported.

WO2008/018981 discloses silicone polymers containing boron, aluminum and/or titanium, and having silicon-bonded branched alkoxy groups and a method of preparing a coated substrate comprising applying a silicone composition on a substrate to form a film and pyrolyzing the silicone resin of the film.

WO2007/102020 discloses a flexible sheet material useful as an energy absorbing material, for example a fabric, impregnated with a dilatant silicone composition. The composition is the reaction product of a polydiorganosiloxane with a boron compound and the silicone composition is modified by reaction with a hydrophobic compound reactive with silanol groups. The hydrophobic compound is preferably a compound of a transition metal selected from titanium, zirconium and hafnium.

US2005/033002 describes a silicone resin comprising structural units comprising a Group IV element.

US2003/118502 describes inorganic hollow fibres obtainable by processing a spinning mass to a hollow fibre wherein the spinning mass is obtained from hydrolytic polycondensation of several compounds including an aluminum or boron compound and a titanium or zirconium compound.

In view of the state of the art, it is the object of the present invention to provide a flame retardant additive system based on strong synergy based on borometalosilicones technology which is cheap, easy to process and with high thermal and moisture stability making them suitable for applications where high processing temperature are required. Moreover, it was demonstrated that the additives presented in the following patent were suitable to reach new norms requirements.

1. The invention provides a silicone resin comprising
a. at least one metallosiloxane which contains Si—O-M bonds whose Metal M is chosen from Transition Group metals, IIIA Group metals, Sn and Zr
b. at least one boron group which contains boron atoms.

Metals M as defined herein encompass transition metals and all metals from Group IIIA. The metals of Group Ma are Al, Ga, In and Tl. Boron, the first element of Group MA is a metalloid not a metal. The Transition Metals are: Scandium Titanium, Vanadium Chromium, Manganese Iron Cobalt, Nickel, Copper, Zinc, Yttrium, Zirconium, Niobium, Molybdenum, Technetium, Ruthenium, Rhodium, Palladium, Silver, Cadmium, Hafnium, Tantalum, Tungsten, Rhenium, Osmium, Iridium, Platinum, Gold, Mercury, Rutherfordium, Dubnium, Seaborgium, Bohrium, Hassium, Meitnerium, Darmstadium, Roentgenium, and/or Copernicium.

Preferably the Metal M is chosen from Period 4 of the transition metals containing Sc, Ti, V, Cr, Mn, Fe, Co, Ni, Cu, Zn. Preferably the Metal M is chosen from nickel, copper and zinc. In other preferred embodiments, the Metal M is chosen from titanium and aluminum (also spelled aluminium). In still other preferred embodiment, the metal is Sn. In other preferred embodiments, the Metal M is Zr.

While borosiloxane structures or other Metal containing structures are known, no prior art suggest a silicone structure containing a metal as defined in addition to B and demonstrating unexpected flame retardant performances synergism compared to their non boron containing counterpart. We have found that such structures may form resins having a high degree of flame retardancy. We have also found that such structures were of particular heat stability compared to their metal and boron containing counterparts, making them suitable for applications where very high processing temperatures are required such as in polycarbonate or polyamide.

The silicone resin composition defined in the present patent can also be obtained through any physical combination of borosiloxane with aluminosiloxane.

The silicone resin preferably contains T units; D; M′ and/or Q units. The resin is characterized by a majority of successive Si—O-M units where the Si is selected from R₃SiO _{1/2} (M′ units), R₂SiO_{3/2} (D units), RSiO_{3/2} (T units) and SiO_{4/2} (Q units). The resin further contains polyorganosiloxanes, also known as silicones, generally comprising repeating siloxane units selected from R₃SiO_{1/2} (M′ units), R₂SO_{2/2} (D units), RSiO_{3/2} (T units) and SiO_{4/2} (Q units), in which each R represents an organic group or hydrogen or a hydroxyl group. Branched silicone resins containing T and/or Q units, optionally in combination with M′ and/or D units, are preferred. Preferably, the molar ratio of Metal atom to Si atom of the silicone resin ranges from 0.01:1 to 2:1.

The invention provides a process for improving the fire resistance and/or the scratch and/or abrasion resistance of a polymeric matrice characterised in that a silicone resin according to any preceding claim is added to a polymer composition.

The fire resistance of the polymeric matrice can be improved by increasing the flame resistance of the matrice, for example by providing flame retardancy properties to the matrice.

The polymer matrice composition can be an already polymerised composition or a monomer composition wherein the resin is added. In the latter case, the resin can be if needed modified beforehand to become reactive with the monomer composition so as to form a copolymer. For example a silicone resin according to the invention can be reacted with eugenol to provide terminal —OH bonds. The modified resin can then be reacted with bisphenol-A and phosgene to provide a Si—O-M-polycarbonate copolymer.

The invention further provides a method for the preparation of a silicone resin, wherein
a. A Metal containing material which material is preferably free of chlorine atoms
b. A Boron containing material
c. A Silicon containing material which material is preferably free of chlorine atoms are hydrolysed and condensed optionally in the presence of an inorganic filler.

This process permits to avoid the use of chlorosilane as raw materials which imply the use of toxic pyridine as solvent, followed by a neutralization step of HCl as described in U.S. Pat. No. 6,716,952. Moreover when using raw materials containing chlorine, high risks to find chlorine left in the final product impeding obtaining desirable halogen free flame retardant compositions. U.S. Pat. No. 6,716,952 don't give any proofs of total absence of residual chlorine atoms in their final product.

The silicone resin can in one preferred embodiment comprise mainly T units, that is at least 50 mole % T units, and more preferably at least 80 or 90% T units. It can for example comprise substantially all T units. In preferred embodiment, the reactant is alkoxysilane, hydroxysilane, alkoxy(poly)siloxane or hydroxyl(poly)siloxane resins.

The boron containing material is preferably selected from (i) boric acid of the formula B(OH)3, any of its salts or boric anhydride, (ii) boronic acid of the formula R1B(OH)2, (iii) alkoxyborate of formula B(OR2)3 or R1B(OR2)2, a mixture containing at least two or more of (i), (ii) or (iii), where R1 and R2 are independently alkyl, alkenyl, aryl or arylakyl substituents.

Preferably, the Metal containing material has the general formula M(R3)ₘ where m=1-7 or depending on the oxidation state of the considered Metal, selected from alkoxymetals where R3=OR′ and R′ is an alkyl group, and metal hydroxyl where R3=OH. Metal chlorides where R3=C1 are preferably avoided so as to guarantee that the product of the reaction is halogen free. When M is Al, the alkoxymetal can be for example (Al(OEt)3, Al(OiPr)3 or Al(OPr)3). Chlorine containing derivatives such as AlCl3 are to be avoided.

The optionally present alkoxysilane is preferably selected from i) tetra(alkoxysilane) Si(OR3)4, (ii) trialkoxysilane R6Si(OR3)3, (iii) dialkoxysilane R6R7Si(OR3)2 or (iv) monoalkoxysilane R6R7R8SiOR3, a mixture containing two or more of (i), (ii), (iii) or (iv), where R3 is a C1 to C10 alkyl group and R6, R7 and R8 are independently alkyl, alkenyl, aryl, arylalkyl, bearing or not organic functionalities such as but not limited to glycidoxy, methacryloxy, acryloxy.

Addition of water during the synthesis is possible but not required. Water loading are calculated minimum to consume partially the alkoxies and preferably the whole alkoxies present in the system. Preferably, the whole mixture is refluxed at a temperature ranging preferably from 50 to 160° C. in the presence or not of an organic solvent. Then the alcohol and organic solvent are stripped and possible remaining water is distilled off from the resin through azeotropic mixture water/alcohol or any other azeotropic system. The use of hydrolysis-condensation catalyst is possible such as but not limited to protic acid (e.g. HCl), lewis acids (Ti or Sn based catalyst) or basic catalysts like KOH.

The obtained product can be further dried under vacuum at high temperature (preferably ranging from 50 to 100° C.) to remove remaining traces of solvents, alcohols or water. These boronated metallosiloxanes demonstrate better heat stability compared to their non-metallised or non-boronated resins counterparts. These resins can be used as additives in polymers or coatings formulations to improve, for example, flame retardancy and/or scratch and/or abrasion resistance.

These new resins can be further blended with various thermoplastics or thermosetting organic polymers or any blends of the laters or rubber or thermoplastic/rubber blends compositions to make them flame retardant. The invention therefore extends to the use of the silicone resin in a thermoplastic or thermosetting organic polymer or rubber or thermoplastic/rubber blends compositions to reduce the flammability of the organic polymer composition. The invention allows a reduction of the emitted fumes upon burning compared to their non boronated and/or non metalized counterparts.

The invention keeps to a certain extent the transparency of the host matrice, i.e. the new resin allows to keep the transparency of the polymer it is blended with or the coating made up with the resin is transparent. The silicone resins of the invention have a high thermal stability which is higher than that of their non-boronated counterparts and higher than that of linear silicone polymers. This higher thermal stability is due to the presence of the metal and boron atom that leads to the formation of highly stable ceramic structures. Such silicone resins additionally undergo an intumescent effect on intense heating, forming a flame resistant insulating char.

The branched silicone resins of the invention can be blended with a wide range of thermoplastic resins, for example polycarbonates, polyamides, ABS (acrylonitrile butadiene styrene) resins, polycarbonate/ABS blends, polyesters, polystyrene, or polyolefins such as polypropylene or polyethylene. It can be blended with a blend of thermoplastic resins. The silicone resins of the invention can also be blended with thermosetting resins, for example epoxy resins of the type used in electronics applications, which are subsequently thermoset, or unsaturated polyester resin. The silicone resin of the invention can also be blended with a blend of thermosetting resins. The mixtures of thermoplastics or thermosets with the silicone resins of the invention as additives have been proved to have a low impact on Tg value and thermal stability, as shown by differential scanning calorimetry (DSC) and thermogravimetric analysis (TGA), and better flammability properties, as shown by UL-94 test, and/or other flammability tests such as the glow wire test or cone calorimetry, compared to their non boronated counterparts. The branched silicone resins of the invention are particularly effective in increasing the fire resistance of engineered thermoplastics and blends of the later with other resins.

The thermoplastic polymer can be chosen from the carbonate family (e.g. Polycarbonate PC), polyamides (e.g. Polyamide 6 and 6.6), polyesters (e.g. polyethyleneterephtalate). The thermoplastic polymer can be chosen from the polyolefin family (e.g. polypropylene PP or polyethylene PE).The thermoplastic resin can be a bio-sourced thermoplastic matrice such as polylactic acid (PLA) or polyhydroxybutadiene (PHB) or bio-sourced PP or PE. The polymer can be chosen from thermoplastic/rubbers blends from the family of PC/Acrylonitrile/styrene/butadiene ABS. The polymer can be chosen from rubber made of a diene, preferably natural rubber. The polymer can be chosen from thermoset from the Novolac family (phenol-formol) or epoxy resin. These above polymers can optionally be reinforced with, for example, glass fibres.

Applications include but are not limited to transportation vehicles, construction, electrical application, printed circuits boards and textiles. Unsaturated polyester resins, or epoxy are moulded for use in, for example, the nacelle of wind turbine devices. Normally, they are reinforced with glass (or carbon) fibre cloth; however, the use of a flame retardant additive is important for avoiding fire propagation.

The silicone resins of the invention frequently have further advantages including but not limited to transparency, higher impact strength, toughness, increased adhesion between two surfaces, increased surface adhesion, scratch and/or abrasion resistance and improved tensile and flexural mechanical properties. The resins can be added to polymer compositions to improve mechanical properties such as impact strength, toughness and tensile, flexural mechanical properties and scratch and/or abrasion resistance. The resins can be used to treat reinforcing fibres used in polymer matrices to improve adhesion at the fibre polymer interface. The resins can be used at the surface of polymer compositions to improve adhesion to paints. The resins can be used to form coatings on a substrate.

The silicone resins of the invention can for example be present in thermoplastic or thermosetting organic polymer or rubber or thermoplastic/rubber blends compositions in amounts ranging from 0.1 or 0.5% by weight up to 50 or 75%. Preferred amounts may range from 0.1 to 25% by weight silicone resin in thermoplastic compositions such as polycarbonates, and from 0.2 to 75% by weight in thermosetting compositions such as epoxy resins.

The invention also provides the use of a silicone resin as defined herein above as a fire- or scratch- and/or abrasion resistant coating on a substrate. The invention also provides a fire- or scratch and/or abrasion resistant coating on a substrate wherein the coating comprises a silicone resin as defined hereinabove.

In certain preferred embodiments, the silicone resin disclosed in the present patent can be used in conjunction with another flame retardant compound. Among the halogen-free flame retardants one can find the metal hydroxides, such as magnesium hydroxide (Mg(OH)₂) or aluminum hydroxide (Al(OH)₃), which act by heat absorbance, i.e. endothermic decomposition into the respective oxides and water when heated, however they present low flame retardancy efficiency, low thermal stability and significant deterioration of the physical/chemical properties of the matrices due to high loadings. Other compounds act mostly on the condensed phase, such as expandable graphite, organic phosphorous (e.g. phosphate, phosphonates, phosphine, phosphine oxide, phosphonium compounds, phosphites, etc.), ammonium polyphosphate, polyols, etc Zinc borate, nanoclays and red phosphorous are other examples of halogen-free flame retardants synergists that can be combined with the silicone material disclosed in this patent. Silicon-containing additives such as silica, aluminosilicate or magnesium silicate (talc) are known to significantly improve the flame retardancy, acting mainly through char stabilization in the condensed phase. Silicone-based additives such as silicone gums are known to significantly improve the flame retardancy, acting mainly through char stabilization in the condensed phase. Sulfur-containing additives, such as potassium diphenyl sulfone sulfonate (known as KSS), are well known flame retardant additives for thermoplastics, in particular for polycarbonate but are only of high efficiency at reducing the dripping effect. In a preferred embodiment, the resin is used in conjunction with Zinc-Borate additive.

Either the halogenated, or the halogen-free compounds can act by themselves, or as synergetic agent together with the compositions claimed in the present patent to render the desired flame retardance performance to many polymer or rubber matrices. For instance, phosphonate, phosphine or phosphine oxide have been referred in the literature as being anti-dripping agents and can be used in synergy with the flame retardant additives disclosed in the present patent. The paper “Flame-retardant and anti-dripping effects of a novel char-forming flame retardant for the treatment of poly(ethylene terephthalate) fabrics” presented by Dai Qi Chen et al. at 2005 Polymer Degradation and Stability describes the application of a phosphonate, namely poly(2-hydroxy propylene spirocyclic pentaerythritol bisphosphonate) to impart flame retardance and dripping resistance to poly(ethylene terephthalate) (PET) fabrics. Benzoguanamine has been applied to PET fabrics to reach anti-dripping performance as reported by Hong-yan Tang et al. at 2010 in “A novel process for preparing anti-dripping polyethylene terephthalate fibres”, Materials & Design. The paper “Novel Flame-Retardant and Anti-dripping Branched Polyesters Prepared via Phosphorus-Containing Ionic Monomer as End-Capping Agent” by Jun-Sheng Wang et al. at 2010 reports on a series of novel branched polyester-based ionomers which were synthesized with trihydroxy ethyl esters of trimethyl-1,3,5-benzentricarboxylate (as branching agent) and sodium salt of 2-hydroxyethyl 3-(phenylphosphinyl)propionate (as end-capping agent) by melt polycondensation. These flame retardant additives dedicated to anti-dripping performance can be used in synergy with the flame retardant additives disclosed in this patent. Additionally, the flame retardant additives disclosed in the present patent have demonstrated synergy with other well-known halogen-free additives, such as Zinc Borates and Metal Hydroxydes (aluminum trihydroxyde or magnesium dihydroxyde) or polyols (pentaerythritol). When used as synergists, classical flame retardants such as Zinc Borates or Metal Hydroxydes (aluminum trihydroxyde or Magnesium dihydroxyde) can be either physically blended or surface pre-treated with the silicon based additives disclosed in this patent prior to compounding.

Therefore, preferably the thermoplastic or thermoset organic polymer composition according to the invention further comprises classical flame retardant additive such as but not limited to inorganic flame retardants such as metal hydrates or zinc borates, magnesium hydroxide, aluminum hydroxide, phosphorus and/or nitrogen containing additives such as ammonium polyphosphate, boron phosphate, carbon based additives such as expandable graphite or carbon nanotubes, nanoclays, red phosphorous, silica, aluminosilicates or magnesium silicate (talc), silicone gum, sulfur based additives such as sulfonate, ammonium sulfamate, potassium diphenyl sulfone sulfonate (KSS) or thiourea derivatives, polyols like pentaerythritol, dipentaerythritol, tripentaerythritol or polyvinylalcohol.

In addition, the resin of the present invention can be used with other additives commonly used as polymer fillers such as but not limited to talc, calcium carbonate. They can be powerful synergists when mixed with the additive described in the present patent.

Examples of mineral fillers or pigments which can be incorporated in the polymer include titanium dioxide, aluminum trihydroxide, magnesium dihydroxide, mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides, and sulphates of sodium, potassium, magnesium, calcium, and barium; zinc oxide, aluminium oxide, antimony pentoxide, antimony trioxide, beryllium oxide, chromium oxide, iron oxide, lithopone, boric acid or a borate salt such as zinc borate, barium metaborate or aluminum borate, mixed metal oxides such as aluminosilicate, vermiculite, silica including fumed silica, fused silica, precipitated silica, quartz, sand, and silica gel; rice hull ash, ceramic and glass beads, zeolites, metals such as aluminium flakes or powder, bronze powder, copper, gold, molybdenum, nickel, silver powder or flakes, stainless steel powder, tungsten, hydrous calcium silicate, barium titanate, silica-carbon black composite, functionalized carbon nanotubes, cement, fly ash, slate flour, bentonite, clay, talc, anthracite, apatite, attapulgite, boron nitride, cristobalite, diatomaceous earth, dolomite, ferrite, feldspar, graphite, calcined kaolin, molybdenum disulfide, perlite, pumice, pyrophyllite, sepiolite, zinc stannate, zinc sulfide or wollastonite. Examples of fibres include natural fibres such as wood flour, wood fibres, cotton fibres, cellulosic fibres or agricultural fibres such as wheat straw, hemp, flax, kenaf, kapok, jute, ramie, sisal, henequen, corn fibre or coir, or nut shells or rice hulls, or synthetic fibres such as polyester fibres, aramid fibres, nylon fibres, or glass fibres. Examples of organic fillers include lignin, starch or cellulose and cellulose-containing products, or plastic microspheres of polytetrafluoroethylene or polyethylene. The filler can be a solid organic pigment such as those incorporating azo, indigoid, triphenylmethane, anthraquinone, hydroquinone or xanthine dyes.

Prophetic example to synthetize Si+Al+B Resin:

### Synthesis of T(Ph)50Al25B25 Resin.

In a round bottomed reactor equipped with a vapor condenser system and a double jacketing heat control system, 81.08gr of aluminium triethoxyde (0.5 mol), 30.92gr of boric acid (0.5 mol), 198.3 gr of phenyl trimethoxysilane (1 mol) will be mixed together with 9 gr of distilled water (0.5 mol). The whitish suspension (due to no dissolved boric acid) will be gently stirred and the system heated-up to 100° C. and refluxed at 100° C. for 3 hours. The reaction evolution will be followed through a quick disappearance of the boric acid to give a transparent, homogenous media. After 3 hours heating, the reactor will be cooled down to 50° C. to cut down the refluxing and the reactor will be equipped with a stripping system. The formed alcohol (Methanol and ethanol) will be removed under vacuum at 50° C. to afford a viscous concentrated resin which will be discharged in a container. The container will be placed a vacuum oven and residual solvent will be stripped at 100° C. to afford T(Ph)50Al25B25 resin as a whitish solid powder.

The obtained powder will be processed as follows:

TABLE 2

| | Time |
|---|---|
| Material to introduce | (min) |
| Chamber T° 270° C., Blade at 50 rotations per minute - add ⅓ of | 0.0 |
| PC resin and close ramp | |
| Add ⅓ of PC resin and after the peak torque close the ramp | 2.0 |
| Add the Si-based material, close the ramp and set the | 3.0 |
| temperature to 260° C. | |
| Add ⅓ of PC resin, set the rotation to 70 RPM and leave | 4.0 |
| the ramp open | |
| close the ramp | 5.0 |
| Drop Batch | 7.0 |

Material will be compression moulded into 100×100×3mm plates. These plates will be used to run thermal characterization as cone calorimeter test.

1. A silicone resin comprising:
a) at least one metallosiloxane comprising Si—O-M bonds, wherein Metal M is chosen from Transition Group metals, IIIA Group metals, Sn and Zr; and
b) at least one boron group comprising boron atoms.

2. The silicone resin according to claim 1 which contains T units;
D units; M′ units and/or Q units.

3. The silicone resin according to claim 1 wherein the Metal M is aluminum, titanium, tin or any mixture thereof.

4. The silicone resin according to claim 1 wherein the molar ratio of Metal atom to Si atom ranges from 0.01 to 2.

5. A process for improving the fire resistance and/or the scratch and/or abrasion resistance of a polymeric matrice comprising: adding a silicone resin according to claim 1 to a polymer composition.

6. Method for the preparation of a silicone resin according to claim 1, wherein:
a) a Metal containing material which material is optionally free of chlorine atoms;
b) a Boron containing material; and
c) a silicon containing material which material is optionally free of chlorine atoms;
are hydrolysed and condensed to form metallosiloxane Si—O-M bonds, optionally in the presence of an inorganic filler.

7. Method according to claim 6 wherein the boron containing material is at least one boron containing material selected from (i) boric acid of the formula B(OH)3, any of its salts or boric anhydride, (ii) boronic acid of the formula R1B(OH)2, (iii) alkoxyborate of formulae B(OR2)3 or R1B(OR2)2, a mixture containing at least two or more of(i), (ii) or (iii), where R1 and R2 are independently alkyl, alkenyl, aryl or arylakyl substituents.

8. Method according to claim 7 wherein the Metal containing material has the general formula M(R3)m where m=1 to 7 depending on the oxidation state of the considered Metal, and wherein the Metal containing material is selected from
i) alkoxymetals where R3=OR′ and R′ is an alkyl group, and
ii) metal hydroxyl where R3=OH.

9. (canceled)

10. (canceled)

11. A thermoplastic or thermoset or rubber or thermoplastic/rubber blend organic polymer composition comprising a thermoplastic or thermoset organic polymer or rubber or thermoplastic/rubber blend and a silicone resin as claimed in claim 1.

12. A thermoplastic or thermoset, any blends of thermoplastic or thermosetting organic polymer or rubber or thermoplastic/rubbers blend organic polymer composition according to claim 11 further comprising a flame retardant additive, wherein the flame retardant additive is selected from metal hydrates, zinc borates, phosphorus and/or nitrogen containing additives, carbon based additives, nanoclays, red phosphorous, silica, aluminosilicates, magnesium silicate (talc), silicone gum, sulfur based additives, or polyols.

13. A fire- or scratch and/or abrasion resistant coating on a substrate wherein the coating comprises a silicone resin according to claim 1.

14. A thermoplastic or thermoset organic polymer composition according to claim 16, wherein the flame retardant additive is selected from magnesium hydroxide, aluminum hydroxide, ammonium polyphosphate, boron phosphate, expandable graphite, carbon nanotubes, sulfonate, ammonium sulfamate, potassium diphenyl sulfone sulfonate (KSS), thiourea derivatives, pentaerythritol, dipentaerythritol, tripentaerythritol or polyvinylalcohol.
